(19) United States
(12) Patent Application Publication
(10) Pub. No.: US 2009/0187499 A1
(43) Pub. Date: Jul. 23, 2009

(54) System, Method and Computer Program Product for Providing Demand Response Functionality

(76) Inventors: David Mulder, Cincinnati, OH (US); Michael Peet, Pittsford, NY (US)

Correspondence Address: CAPITAL LEGAL GROUP, LLC, 1100 River Bay Road, Annapolis, MD, 21409, US

(21) Appl. No.: 12/354,262

(22) Filed: Jan. 15, 2009

Related U.S. Application Data
(60) Provisional application No. 61/022,464, filed on Jan. 21, 2008.

(51) Int. Cl. G06Q 50/00; G06F 1/32; G05D 23/19; G06Q 10/00; G06F 3/048

(52) U.S. Cl. 705/30; 700/295; 700/299; 705/412; 715/771

(57) ABSTRACT

A system, method and computer program product for providing demand response in a power grid is provided. In one embodiment, the computer system may include a first module configured to store user profile data for a plurality of users in memory and wherein user profile data includes load shed participation data for at least some of the plurality of users, information identifying one or more load control devices associated with each of the plurality of users, and location data of a premises associated with the user. The system may include a second module configured to select a multitude of the users based, at least in part, on the load shed participation data of the profile data, a third module configured to transmit a first control message to a load control device of the selected users, wherein the control message comprises a request to reduce a load.

### CROSS REFERENCE TO RELATED APPLICATIONS

This application claims the benefit of U.S. Provisional Application No. 61/022,464, filed Jan. 21, 2008, entitled “System, Method and Computer Program Product for Providing Demand Response Functionality via a Power Line,” which is incorporated herein by reference in its entirety for all purposes.

### FIELD OF THE INVENTION

The present invention generally relates to systems and methods for managing power distribution systems, and more particularly to systems, methods and computer products for providing demand response within a power distribution system.

### BACKGROUND OF THE INVENTION

The power used at a plurality of customer premises, such as by appliances, electronic devices, and equipment, determines the load on the power distribution system. In efforts to conserve power and/or to reduce the stress on the power distribution system (such as during times of peak power load), it is desirable to better manage the load on the power distribution system. Various direct load control devices exist to reduce or remove (shed) loads from the power system. A thermostat installed at a customer's premises, in some instances, can be considered a direct load control device. Other direct load control (DLC) devices may control pool pump to allow the pool pump to be turned off and on. Other DLC devices may control heating or lighting. Such load control devices enable the utility (or its customers) to control the power consumed.

There is a need for systems and methods that allow a utility or other central provider to access and control load control devices, such as may be installed at customer premises. In particular, there is a need to more efficiently manage demand within portions of the power grid, such as within one or more power distribution systems by managing load control device settings. These and other needs may be addressed by one or more embodiments of the present invention.

### SUMMARY OF THE INVENTION

The present invention provides a system, method and computer program product for providing demand response in a power grid. In one embodiment, the computer system may include a first module configured to store user profile data for a plurality of users in memory and wherein user profile data includes load shed participation data for at least some of the plurality of users, information identifying one or more load control devices associated with each of the plurality of users, and location data of a premises associated with the user. The system may include a second module configured to select a multitude of the users based, at least in part, on the load shed participation data of the profile data, a third module configured to transmit a first control message to a load control device of the selected users, wherein the control message comprises a request to reduce a load.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an environment for providing demand response in a power distribution system, according to an example embodiment of the present invention;

FIG. 2 is a block diagram of computer program modules for implementing demand response functionality within a power distribution system, according to an example embodiment of the present invention; and

FIG. 3 is a flow chart of a method for providing demand response functionality within a power distribution system, according to an example embodiment of the present invention.

### DETAILED DESCRIPTION OF ILLUSTRATIVE EMBODIMENTS

In the following description, for purposes of explanation and not limitation, specific details are set forth, such as particular networks, devices, communication systems, computers, terminals, components, techniques, data and network protocols, power line communication systems (PLCSs), software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, devices, communication systems, computers, terminals, components, techniques, data and network protocols, software products and systems, operating systems, development interfaces, and hardware are omitted so as not to obscure the description of the present invention.

According to an example embodiment of the present invention, a system, method and computer program is provided for implementing demand response functionality within a power distribution system. The demand for power may vary depending on the season, weather and time of day. For example, during the summer months, the load drawn by air conditioning equipment in warm climates may put a strain on a power utility's ability to provide power to all customers. In some instances, the utility company even may be forced to implement rolling brownouts to prevent the power system from failing. Demand response functionality includes the ability to control the load to reduce (or increase) demand in response to various supply conditions. To provide such functionality, various load control devices may be installed at a plurality of customer premises. For example, a thermostat configured to be responsive to control messages received from a remote computer system may serve as a load control device. Customers may, for example, give permission to the utility company to modify the thermostat during high power demand situations. More specifically, during a high power demand situation (e.g., a hot day), the utility company may remotely access the thermostat of one or more power customers to turn off the air conditioning or increase the temperature setting of the customer's thermostat (i.e., to reduce power consumed by the air conditioning system). As the demand for power decreases, the utility may also restore the original thermostat settings to those customer premises. While this and many of the examples described herein include a thermostat as the load control device, the invention is not so limited and may be used to control other load control devices that can shed a load (turn off the load) and other load control devices that can reduce the load (e.g., a water heater) such as those similar to a thermostat in which the temperature setting (or other setting) is changed thereby reducing the collective load on the system and cumulative power consumed by the load (e.g. the air conditioning system) without completing shedding the load.

Demand response may be provided using various load control devices. In addition to the example of a thermostat serving as a load control device, another example of a load control device may include a load control switch which either turns off the load or prevents power from being used by the load (in effect turning the load off). For example a pool heater and/or filtration system may include a load control switch which allows the system to operate in a low power mode, (e.g., with reduced functionality). In some embodiments, the load control switch may simply turn off power to a load (e.g., a light). Load control switches may be used to control any device that consumes significant power such as a pool pump, pool heater, heat pump (AC or heat), some (typically outdoor) lighting, etc. During a high demand situation, the utility company may remotely access (provide control messages to) the load control switches to turn off or reduce power to the load source. The utility company may do this for one or more customers to reduce the load on a power distribution system. As the power demand decreases, the utility can return the load control switches to their original configurations (for the select homes, neighborhoods or regions having been affected).

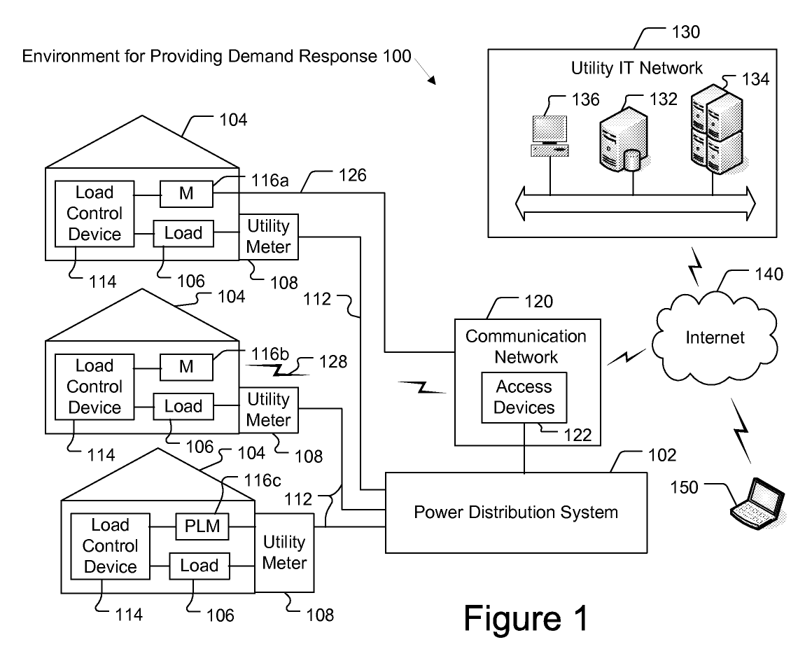

FIG. 1 shows an environment 100 for providing demand response functionality in a power distribution system 102 serving a plurality of customer premises 104. Each customer premises 104 may include various appliances, equipment and other devices that constitute loads 106 to the power distribution network 102. In particular, each such load 106 may be plugged into the internal power lines of the customer premises, which are coupled to a power meter 108. Typically, low voltage power lines 112 extend from the premises 104 to a distribution transformer (not shown) within the power distribution system 102.

At participating customers' premises, one or more load control devices 114 may be installed. The load control device 114 may be coupled to a given load 106, such as to a heating, ventilation and air conditioning (HVAC) system or to a pool pump. The utility company, their agent, another service provider, or the customer may access the load control device to control the load control device 114. For example, the load control device 114 may include (or be coupled to) a communication device 116, such as a modem, allowing communications through a communication network 120. In various embodiments, the link between the communication device 116 and an access device 122 of the communication network 120 may be achieved via wired or wireless media. In one embodiment, a wired media such as a coaxial cable, telephone wire, fiber, or other wire 126 may provide the medium. For example, the communication device 116 may be a cable modem 116a coupled to a coaxial cable that extends to the access device 122. In another embodiment, the link may comprise a wireless link 128, such as between a wireless modem 116b and the access device 122. In still another embodiment, a power line (e.g., low voltage power line 112) may provide the medium, such as between a power line modem 116c and the access device 122.

In various embodiments, the communication network 120 may provide access by any one or more of wired, wireless and power line media. For example, the communication network 120 may form part of a mobile telephone network, paging network, WiMAX network, wide area network (WAN), coaxial cable network, DSL network, or some combination thereof. In some embodiments all or a portion of the communication network 120 may be provided by a power line communication system (PLCS). Detailed descriptions of examples of a PLCS, along with system elements such as bypass devices (also referred to as access devices), backhaul points, repeaters (e.g., a bypass device acting as a repeater), power line servers, sensors, other components and their functionality are provided in U.S. Pat. No. 7,224,272, issued May 29, 2007, entitled “Power Line Repeater System and Method,” which is hereby incorporated by reference in its entirety for all purposes. Additional descriptions of such devices, sensors, components and their functionality is provided in U.S. patent application Ser. No. 11/423,206, filed Jun. 9, 2006, entitled “Power Line Communication Device and Method,” which is hereby incorporated by reference in its entirety for all purposes. The load control devices 114 may be connected to and controlled via a bypass device, backhaul point, repeater and/or other device in such PLCS embodiments.

In an example embodiment in which the communication system 120 is implemented at least in part by a PLCS, a bypass device (BD) may serve as the access device 122 and connect to (and communicate) with one or more load control devices 114 via a low voltage power line. For example, communications may be transmitted from the BD (e.g., access device 122) along power lines of the power distribution system 102, to a power line modem 116c coupled to the load control device 114, and from the power line modem 116c along power lines 112 to the access device 122.

In some embodiments, a wireless link may be implemented between a communication device 116b and the access device 122. For example, a communication may be received at the PLCS (such as from the internet—wirelessly or via the power line), propagate through the PLCS toward a particular access device 122, then be transmitted wirelessly to a wireless modem 116b coupled to a load control device 114. Similarly, a communication may be transmitted wirelessly from the load control device 114 (or wireless modem 116b) to the access device 122, then be transmitted through the PLCS along power lines.

In the various implementations of a PLCS, the BD or other device serving as the access device 122 may communicate with multiple sets of load control devices in multiple homes. The BD may control various loads (via one or more load control devices in the home) via a wireless and/or wired link to thereby control power consumption.

A utility information technology (IT) network 130 may host software for monitoring and controlling the load control devices 114. In some embodiments the utility IT network 130 also may store or otherwise access information pertaining to the power distribution network 102. In particular, the utility IT network 130 may include a database server 132, a web server 134, and monitoring and control application servers, along with various work stations, terminals or other computers 136 for locally or remotely accessing the utility IT network 130. In an example embodiment, communications may occur between the communication system 120 and the utility IT network 130 via the internet 140.

In some embodiments, a remote computer 150 may store or otherwise access software for monitoring and controlling load control devices 114. For example, a technician with appropriate privileges may remotely access the utility IT network 130 via the internet 140 to monitor or control one or more load control devices 114 through a web interface. As another example, a customer may monitor and control the settings of one or more load control devices 114 at the customer's premises 104 remotely from a computer 150 via the internet 140 through a web interface served by the servers 134.

More specifically for example, a power customer may log into a web server 134 to control his or her power loads. Based on the received customer information, the server 134 may communicate with the load control device 114 to control a load. For example, the load control device 114 may modify the temperature setting of the HVAC system for the customer's home at different times of the day and week. The customer, for example, may set a weekly schedule for the temperature. In some embodiments the customer may create a user profile, such as to control temperature and other load conditions. The user profile (also referred to herein as customer profile) may include data to provide a fixed weekly schedule for device settings. The customer user profile also, or alternatively, may include data for adjusting the load based on the price of power at any moment in time. For example, when the price of power exceeds a threshold value, the air conditioner temperature setting may be altered to reduce the power consumed by the air conditioner. As another example, the customer profile information supplied by the customer may include a budgeting feature ensure the monthly power bill remains below a desired value. The budget may be implemented by the IT network 130, for example, as a monthly budget and pro-rated (e.g., divided by thirty) to determined an allotted daily power cost. Each day of the billing cycle a cumulative budgeted power cost is computed (e.g., by multiplying the allotted daily power cost by the number of days into the cycle) and the actual cumulative power cost is retrieved from memory. When compared and the actual cumulative power cost for the cycle (to date) exceeds the cumulative budgeted power cost by a predetermined threshold (e.g., ten percent, twenty percent, etc.), the server may transmit control messages to the load control devices 114 of that power customer to shed and/or reduce loads to reduce energy consumption in order to bring the cost of the monthly power consumption in line (down) in order to maintain the monthly budget. Such load adjustments may be for the current day or extend to additional days to get reduce the power expenses incurred until the actual cumulative power fees satisfy a similarity threshold (e.g., within five percent) with the cumulative budgeted power cost. The customer profile may store information about budget and the various loads and load control devices, (e.g., heat pump or not connected to the thermostat) to determine whether a given load source (e.g., heating subsystem) can be controlled (such as in addition to controlling the air conditioning subsystem).

One advantage of providing the customer is that a customer may log in from a remote location to change the temperature setting or other load source setting at the customer's premises. For example, if the customer is going home early on a summer day, the customer can login from work and lower the temperature setting of the thermostat controlling the air conditioning. As another example, a customer may login from work, or even from their smart phone while driving home, to turn on a pool heater or sauna. Thus, from any location a customer may access and control his or her in-home loads and/or thermostat.

In an example embodiment of the present invention, demand response functionality is provided at least in part by an executable computer program product stored in a tangible medium. For example, the demand response functionality may be implemented with a user-friendly dashboard (executable computer program product) that executes on a computer system remote from the power line communication system (PLCS) or other communication network 120 for managing demand response events. Examples of demand response may include having power customers agree to allow the computer system reduce their consumption at critical times (e.g., high demand or peak power loading times), or reduce their power consumption in response to market prices or consumer expenses (e.g., reduce their load when the price of the power being supplied rises above a threshold or to maintain the customer's budget as discussed above). Whether used as the primary control system or as an interface with a third-party application, the example embodiment of the present invention provides a seamless control and reporting capability.

Various actions and reports may be provided to provide demand response capability within the power distribution system 102. Examples of actions that may be supported follow:

Load from a single source or premises may be shed or reduced upon command.

Load from multiple sources or premises may be shed or reduced upon command.

Load from a single source or premises may be restored upon command.

Load from multiple sources or premises may be restored upon command.

A thermostat may be adjusted a specified number of degrees in either direction upon command (e.g., in response to a user profile which is configurable via user input via a web interface).

The thermostat may be adjusted a specified number of degrees in either direction upon command for multiple thermostats at one or more customers' premises.

The temperature reading may be obtained for one or more thermostats at one or more customers' premises.

The thermostat may be set to a specific temperature for one or more thermostats at one or more customers' premises.

Internal diagnostics may be read from a thermostat or other load control device.

A load control device may monitor for various alarm conditions.

Alarm conditions, such as a loss in communication, may be configurable.

The load control devices may be polled periodically for alarm conditions.

Various reports may be generated to provide load and load control device condition, and status for a given customer's premises or for multiple customers premises. Such actions and reports allow for automated and requested demand control functionality of all or portions of a power distribution system 102.

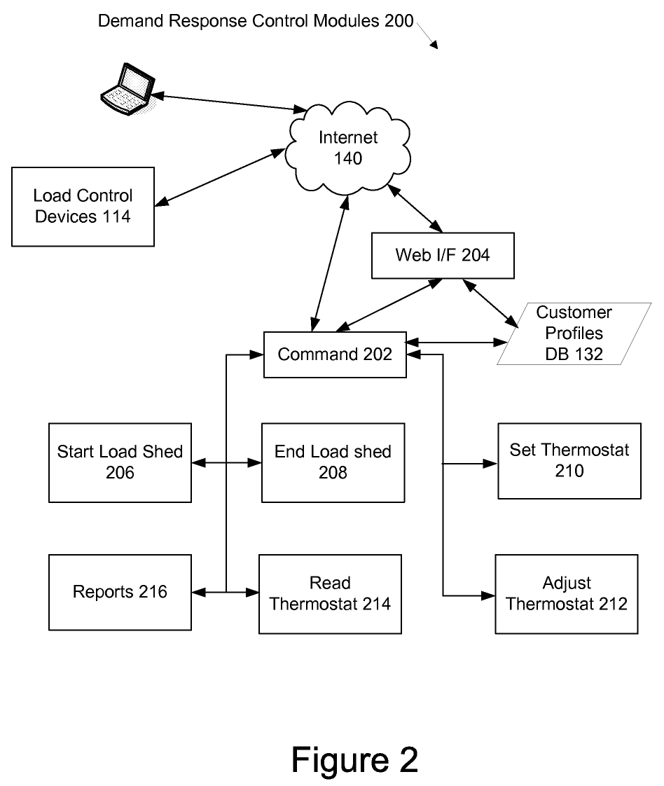

FIG. 2 shows a diagram of demand response control modules 200, including a command module 202, user interface module 204, start load shed module 206, end load shed module 208, Set thermostat module 210, adjust thermostat module 212, read thermostat module 214, and a reports module 216. Other embodiments may include additional, fewer, and/or different modules.

User interface module 204: The user interface module 204 may provide an interface for customers, technicians, or other personnel to login to create, modify or delete various accounts, profiles, and settings. For example, the settings of specific load control device 214, such as load control switches and thermostats, may be set or adjusted. Customer profile data may be input and edited (e.g., budget; temperature for various times; whether the customer agrees (or not) to participate in load shedding/reduction; the type of heat; the number of zones; load control switch data (such as which control switches can be turned off during peak power times, to save money during peak pricing, and/or to maintain the monthly budget)). The user interface module 204 may include and serve the web interface and retrieve and store data in the customer profile database 132.

Command module 202: The command module 202 controls the operation of the other software modules. For example, in response to user inputs, automated communications, and data processing, various commands may be transmitted. Based on information in the customer profiles database, the command module may cause various other software modules to execute such as, for example, based on the time of day.

Start Load shed Module 206: A single load (or loads at a single premises) may be shed or reduced upon command. Similarly, multiple loads or loads at multiple premises may be shed (turned off or reduced) upon command. In an example embodiment, when a load shed event is commanded, various operations may be implemented. The load shed command may include an IP address for the load control device 114 that controls the load to be shed or reduced. Such shedding as previously described may include changing the temperature setting of one or more thermostats or turning off a device. When multiple loads are to be shed (including their load reduced), the start load shed module 206 may cause multiple commands to be transmitted to each of multiple load control devices 114 across a county, region, or state. The transmission may include any of unicast, multicast, or broadcast transmission as appropriate.

When a load is shed, the command module 202 may also execute other software modules and/or other processes. For example, when a load is shed the thermostat setting at each address where a load is being shed may be read, and the thermostat temperature at each address where load is being shed may be read. Such information may be stored in memory (e.g., in the DB). In addition, the local time when the shed command is sent to the load control device(s), and the local time when a shed acknowledgement is received back from the load control device may be stored. Furthermore, the meter consumption at each customer premises where load is being shed may be read and stored (e.g., per fifteen minute power consumption before and after the load shed). The meters may be read periodically or intermittently according to a given command scenario. In this embodiment, local time is recorded throughout while in other embodiments UTC time is recorded and converted to local time as necessary such as for reports.

End Load Shed Module 208: A single load (or load at a single premises) may be restored upon command (i.e., restored to their value prior to being shed). Similarly, multiple loads or loads at multiple premises may be restored upon command. The end load shed command may include an IP address for the load control device 114 that controls the load to be restored. Such restoration may include changing the temperature setting (or adjusting the thermostat) of one or more thermostats or turning on a load. When multiple loads are to be restored, the end load shed module 208 may cause multiple commands to be transmitted to each of multiple load control devices 114 across a county, region, or state. The transmission may include any of unicast, multicast, or broadcast transmission as appropriate.

When a load is restored, the command module 202 also may execute other software modules and/or perform other processes. For example, when a load is restored the thermostat setting at each address where load is being restored may be read, and the thermostat temperature at each address where load is being restored may be read. Such information may be stored in memory. In addition, the local time when the restore command is sent to the load control device(s), and the local time when a restore acknowledgement is received back from the load control device may be stored. Furthermore, the meter consumption at each customer premises where load is being restored may be read and stored (e.g., per fifteen minute power consumption before and after the load restoration). In one example, a load is restored by retrieving (from memory) the thermostat setting recorded prior to a thermostat setting or adjustment command that was used to shed a load. The retrieved data may be sent to the thermostat to restore the earlier setting.

Set Thermostat Module 210: A thermostat setting may be set to any temperature by the Set Thermostat module 210. The command module 202 may implement the set thermostat module 210 to set the thermostat to any desired temperature based on the user profile data and/or the time of day, the price of power, the cumulative cost of power for a customer, etc. In some embodiments, data from the user profile is transmitted to the load control device (e.g., a thermostat) for storage therein. In such an example embodiment, the command module may transmit new data when the user modifies his or her customer profile. Command may include the IP address of the thermostat to be provided the command or data.

When a thermostat setting is set, the command module 202 also may execute other software modules and/or perform other processes. For example, when a thermostat setting is set, the prior thermostat setting at each address as well as the thermostat temperature may be read. Such information may be stored in memory. In addition, the local time when the thermostat setting command is sent to the thermostat(s), and the local time when an acknowledgement is received back from the thermostat device may be stored. Furthermore, the meter consumption at each customer premises where the thermostat setting is set may be read and stored (e.g., per fifteen minute power consumption before and after the setting).

Thermostat Remote Adjust Module 212: A thermostat may be adjusted a specified number of degrees in either direction by the Thermostat Adjustment Module 212 which may be executed by the command module 202 in response to customer profile data which is configurable by the customer via a web interface, upon receipt of a request to adjust the temperature from the customer, by other automatically generated commands (e.g., based on a monthly budget, the price of power, the overall demand of power, etc.). Such commands may include an IP address(es) of thermostat(s) to receive the command.

When a thermostat is adjusted, the command module 202 also may execute other software modules and/or other processes. For example, when a thermostat is adjusted, the prior thermostat setting at each address as well as the thermostat temperature may be read. Such information may be stored in memory. In addition, the local time when the thermostat adjustment command is sent to the thermostat(s), and the local time when an acknowledgement is received back from the thermostat device may be stored. Furthermore, the meter consumption at each customer premises where the thermostat is adjusted may be read and stored (e.g., per fifteen minute power consumption before and after the load shed). The meters may be read periodically or intermittently according to a given command scenario.

Read Thermostat Module 214: The read thermostat module 214 may transmit a command to read a thermostat that may include an IP address of the thermostat. Various operations also may be performed, including: read the present setting of the thermostat; and record the local time at which the temperature reading was obtained.

The operations performed for each command described above may include one or more communications which are transmitted to a load control device and received from a load control device. For example, a specific module 202-214 may request that one or more communications be sent to one or more load control devices at one or more premises. The load control device may process the communication to gather data and/or implement load changes. The load control device 114 may generate a communication in response such as to acknowledge a request to change a thermostat's setting or a load control switches position, and to transmit requested data.

In some embodiments, a customer or technician uses a web interface to request actions. A monitoring and control application server 134 may host the web interface (e.g., web interface 204) and the underlying processing. During such processing, data may be retrieved from the database server 132. The communications for obtaining the data may be sent via the internet 140 and communications network 120 to specific load control devices 114 at specific premises 104 (see FIG. 1). Similarly, responses may be sent from the specific load control devices 114 via various communication devices 116 through the communication network 120 and internet 140 back to the servers 134. The data then may be formatted for display by the web interface module 204 allowing a remote user to view the data via a web interface (e.g., in a web browser executing on the user's computer which accesses the data from the server 134 via the internet 140).

Reports Module 216: Various reports may be generated to provide load and load control device condition and status for a given customer's premises or for multiple customers' premises. Further, some of the commands requested by a customer, technician or other user may include requests for data or other results to be displayed or otherwise reported back to the user. Following are examples of a couple reports. One of ordinary skill in the art to which the invention pertains will appreciate that other reports also may be generated.

For a load shed and load restore command affecting a given customer premises, an individual load shed analysis report may be generated. This report may include the following information about the customer such as the address where the shed occurred; the start and stop times of the shed event; the total event duration; and the amount of power consumption that occurred during the event (e.g., when meter data is read at the load shed and restoration). In addition, a graph of the power consumption at the premises for the twenty-four hour day during which the event occurred may be derived. If the shed event extends for more than one day, then the graph may show consumption for all the days of the event. Other information in the report may include the thermostat temperatures at the stop and start of the event; the thermostat settings at the start and stop times of the event; and the time difference between the load shed command and restoration (or acknowledgement).

For a load shed and load restore scenario affecting a group of customers premises, a group load shed analysis report may be generated. This report may include information such as the number of addresses being affected by the shed; the start and stop times of the shed event; the total event duration; and the total amount of power consumption that occurred during the event at all the premises (e.g., when meter data is read at the load shed and restoration). In addition, a graph of the power consumption at the premises for the twenty-four hour day during which the event occurred may be derived. If the shed event extends for more than one day, then the graph may show consumption for all the days of the event.

According to an example embodiment of the present invention, a communication network 120 is used to provide demand response functionality within a power distribution system. A user may remotely input data which affects the demand response functionality. For example, a request may be input by the user pertaining to a load control device at a customer premises. A control message may be transmitted through the communication network 120 which ultimately reaches the load control device 114 at a customer's premises 104. The load control device 114 responds to the control message to modify demand for the customer premises. For example, the control message may include temperature control data for a load control device (e.g., a thermostat) to affect an HVAC system. In some instances, demand response functionality may affect multiple load sources at a customer's premises. For example, a given customer's premises may include a thermostat for controlling an HVAC system, along with a load control switch for controlling another load. In such an embodiment the load control data may include temperature control data for the HVAC system, and a load control switch setting for controlling such other load.

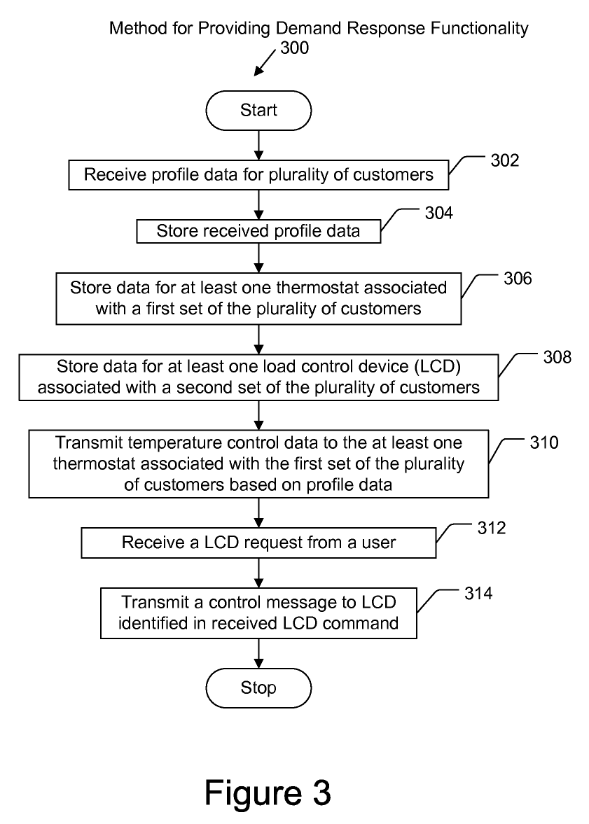

FIG. 3 depicts a flow chart of a method 300 for providing demand response functionality for a plurality of customers having associated customer premises, according to an example embodiment of the present invention. At step 302, customer profile data is received for a plurality of users such as, for example, via the web interface. At step 304, the customer profile data is stored in a memory in a database. The customer profile data for each customer may include data identifying various loads, information identifying the load control device associated with each load, a status of whether the customer has enabled demand response functionality (load shedding) for a given load (i.e., whether the customer agrees to allow the utility to shed that load such as during periods of high power demand), a programmable time schedule for controlling one or more loads (although this feature may not be used by all customers or in all embodiments), a monthly budget, a power price threshold (e.g., to be used as a trigger to shed loads), and other data pertaining to a customer account, the customer's premises, and the various loads. Not all customers need participate in all aspects of the demand response functionality and therefore the database may not store all of these data types for each customer. In addition, some embodiment may not implement all such demand response features.

At step 306, data for at least one thermostat associated with a first set of the plurality of customers is stored. At step 308, data for at least one load control device associated with a second set of customers is stored. In one embodiment the various customer profile data, thermostat data, and load control device data may be stored within the same data structure at the database server 132.

Periodically, the customer profile data and other data may be accessed to implement demand response functionality. For example, at step 310, the adjust temperature module 212 may be executed to transmit temperature control data to at least one thermostat associated with the first set of the plurality of customer premises based upon the customer profile data.

As discussed, the customer may provide different temperature settings at different times of the day, week, and/or month. Thus, the command module 202 may monitor the time so as to execute the appropriate modules to transmit commands to the load control devices 114 (including thermostats) to ensure that the customer's profile settings are maintained with respect to temperature settings and power consumption. Alternately, the command module 202 may transmit new configuration data (temperature settings and times) for storage control in the thermostat. In addition, the command module 202 may also execute one or modules to reduce the power consumption of a customer premises to (1) adhere to a power budget that is supplied by the customer; and/or (2) reduce consumption of power during peak times of pricing or high demand. In addition, the command module 202 may also execute one or modules to reduce the power consumption of one or more customer premises in response to a control message received from the electric power utility such as a command to shed loads (e.g., due to strain on the power generation or distribution network). Such control message may be a request to shed as much load as possible or identify specific substations (or other areas) in which loads should be shed. In either instance, the command module 202 may access the customer profile database to identify the loads in the power grid or the loads in a specific area of the power grid for which the associated power customer has agreed to allow the utility to shed such loads (and subsequently transmit commands to shed such loads).

The customer, a technician or other personnel with appropriate privileges may update the customer profile, such as to modify the weekly schedule or to modify load control device parameters, or to otherwise modify their account information. Accordingly, at step 312, a request may be received from a user pertaining to load control. At step 314, a control message then may be transmitted to a load control device 114 based upon the received user request. Different customers may change load control information. For example, one customer may log in to change a temperature setting. Another customer may login to change a load control switch, such as for a pool heater. In each instance, a command may be received pertaining to load control, and a control message sent to the appropriate load control device to implement the change. In addition, the database may store the IP addresses, the physical address, and customer profile data associated with each customer account and be accessed by the command module 202 for transmitting commands. The database may store information about the IP address, and the type and format of control messages to be sent to each load control device.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of using a computer system to provide load control in a power grid for a plurality of users, each user having an associated customer premises, comprising:
storing profile data of a plurality of users in a memory;
wherein the profile data comprises:
load shed participation data for at least some of the plurality of users;
information identifying one or more load control devices associated with each of the plurality of users; and
location data of a premises associated with each user;
selecting one or more users for load shedding based, at least in part, on their profile data;
transmitting a first control message to a load control device of at least some of the one or more users;
wherein the control message comprises a request to load shed;
receiving a first user command from a first user;
wherein the first user command comprises a request to control a thermostat; and
transmitting a second control message to a thermostat of the first user to control the thermostat.

2. The method according to claim 1, wherein said selecting comprises accessing the profile data to identify one or more users having agreed to participate in a load shed.

3. The method according to claim 2, wherein said selecting further comprises accessing the profile data to select one or more users based on the location data of the premises associated with each user.

4. The method according to claim 3, wherein said selecting comprises selecting the one or more users having an associated premises connected to the power grid in an area experiencing a demand for power above a threshold.

5. The method according to claim 1, wherein said selecting comprises accessing the profile data to select one or more users based on the location data of the premises associated with each user.

6. The method according to claim 1, wherein said selecting comprises selecting the one or more users having an associated premises connected to the power grid in an area experiencing a demand for power above a threshold.

7. The method according to claim 1, wherein the first control message includes temperature control data for a thermostat.

8. The method according to claim 1, further comprising:
storing a threshold value in memory in association with a second user;
determining an existing price for power provided to a premises of the second user;
determining that the existing price is above the threshold value associated with the second user; and
transmitting a third control message to a load control device associated with the second user to reduce the power consumption of the second user.

9 The method according to claim 1, further comprising:
storing a power budget of a second user in memory;
determining an actual cumulative power cost associated with power supplied to a premises associated with the second user for a present billing cycle;
determining a budgeted cumulative power cost based on the power budge of the second user;
comparing the actual cumulative power cost with the budgeted cumulative power cost; and
determining whether to reduce the power consumption of the second user based on said comparing.

10. The method according to claim 1, further comprising receiving the profile data from the plurality users via the internet.

11. The method according to claim 1, further comprising:
receiving a request via the internet for power data from a user; and
transmitting data of consumed power and of a cumulative power cost for that user to the user.

12. The method according to claim 1, further comprising:
generating a load shed event report that comprises:
a customer address where a load was shed;
a start time and a stop time of the load shed event;
a total load shed event duration; and
an amount of power consumed during the load shed event; and
outputting the report.

13. The method according to claim 1, further comprising a power consumption module configured to receive power consumption data derived from information transmitted by a plurality of automated power meters.

14. The method according to claim 1, further comprising transmitting a third control message to at least some of the load devices receiving the first control message; and
wherein the third control message comprises a command to restore the load.

15. The method according to claim 14, wherein the third control message comprises a command to set a thermostat to a temperature setting.

16. A computer system for providing demand response in a power grid, comprising:
a first module configured to receive and store a first user input related to a first load control device from a first user;
wherein the first user input comprises a modification of a thermostat setting;
a second module configured to transmit a first control message to the first load control device and wherein the first control message is configured to modify a thermostat setting;
a third module configured to transmit a request for temperature data and to store a response to said request; and
a fourth module configured to store user profile data for a plurality of users in memory and wherein user profile data comprises:
load shed participation data for at least some of the plurality of users;
information identifying one or more load control devices associated with each of the plurality of users; and
location data of a premises associated with each user.

17. The system according to claim 16, wherein the profile data further comprises a power budget in association with a second user, the system further comprising a fifth module configured to:
determine an actual cumulative power cost associated with a premises associated with the second user for a present billing cycle;
determine a budgeted cumulative power cost based on the power budget associated with the second user;
compare the actual cumulative power cost with the budgeted cumulative power cost; and
determine whether to reduce the power consumption of the second user based on said comparing.

18. The system according to claim 17, wherein the profile data further comprises a threshold value in association with a third user, the system further comprising a sixth module configured to:
determine an existing price for power provided to the third user;
determine that the existing price is above the threshold value associated with the third user; and
transmit a second control message to a load control device associated with the third user to reduce the power consumption of the third user.

19. The system according to claim 16, wherein the profile data further comprises a threshold value in association with a second user, the system further comprising a fifth module configured to:
determine an existing price for power provided to the second user;
determine that the existing price is above the threshold value associated with the second user; and
transmit a second control message to a load control device associated with the second user to reduce the power consumption of the second user.

20. A computer system for providing demand response in a power grid, comprising:
a first module configured to store user profile data for a plurality of users in memory and wherein user profile data includes:
load shed participation data for at least some of the plurality of users;
information identifying one or more load control devices associated with each of the plurality of users; and
location data of a premises associated with each user;
a second module configured to select a multitude of the users based, at least in part, on the load shed participation data of the profile data;
a third module configured to transmit a first control message to a load control device of the selected users; and
wherein the control message comprises a request to reduce a load.

21. The system according to claim 20, wherein the second module is configured to select the multitude of users based on the location data of the premises associated with each user.

22. The system according to claim 20, wherein the second module is configured to select users having an associated premises connected to the power grid in an area having a power demand above a threshold.
